(19) United States
(12) Patent Application Publication
(10) Pub. No.: US 2009/0056874 A1
(43) Pub. Date: Mar. 5, 2009

(54) LOWER ELECTRODE ASSEMBLY FOR PROCESSING SUBSTRATES

(76) Inventors: Gyeong Hoon KIM, Anyang-si (KR); Young Bae Ko, Suwon-si (KR)

Correspondence Address: KED & ASSOCIATES, LLP, P.O. Box 221200, Chantilly, VA, 20153-1200, US

(21) Appl. No.: 12/143,888

(22) Filed: Jun. 23, 2008

(30) Foreign Application Priority Data
Sep. 5, 2007 (KR) 10-2007-0090126

(51) Int. Cl. C23F 1/08; B05C 11/00

(52) U.S. Cl. 156/345.3; 118/620

(57) ABSTRACT

A lower electrode assembly includes an insulator and a lower electrode material. The lower electrode material includes a peripheral portion having three level surfaces. The first level surface supports a substrate having a predetermined width and length. The second level surface has a width that corresponds to the predetermined width of the substrate plus a first increment and a length that correspond to the predetermined length of the substrate plus a second increment. The third level surface has a lower height than the second level surface. The insulator is provided horizontally on the second level surface and third level surface.

### BACKGROUND

1. Field

One or more embodiments described herein relate to processing substrates including semiconductor substrates

2. Background

A variety of flat panel displays (FPDs) are known. Examples include liquid crystal displays (LCDs), plasma display panels (PDPs), and organic light-emitting diodes (OLEDs). These displays and other electronic devices are manufactured using substrate processing apparatuses that include load lock, transfer, and/or process chambers. Apparatuses of this type tend to be expensive and inadequate for purposes of treating substrates of different sizes. They also fail to take adequate precautions for protecting the chambers and their components from corrosion resulting from the use of plasma during substrate processing.

### BRIEF DESCRIPTION OF THE DRAWINGS

FIG. 1 is a diagram showing one type of lower electrode assembly in a substrate processing apparatus.

FIG. 2 is a diagram showing another view of the lower electrode assembly of FIG. 1.

FIG. 3 is a diagram showing another type of lower electrode assembly that may be included in a substrate processing apparatus.

FIG. 4 is a diagram showing another view of the lower electrode assembly of FIG. 3.

### DETAILED DESCRIPTION

A substrate processing apparatus includes a load lock chamber, a transfer chamber, and a process chamber. The load lock chamber receives an untreated substrate from an external source and/or carries a treated substrate to another chamber or location, while alternately maintaining atmospheric and vacuum states. The transfer chamber transfers a substrate from the load lock chamber to a process chamber, and/or transfers a treated substrate from the process chamber to the load lock chamber. The process chamber processes a substrate which, for example, may involve the formation of a film or an etching operation using plasma or thermal energy in a vacuum state. Transfers between chambers may be performed by a robot.

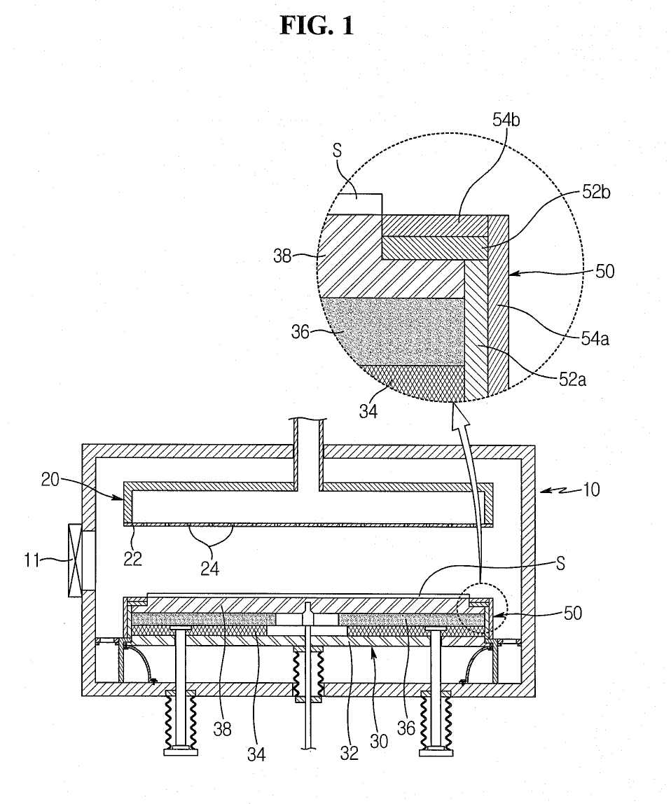

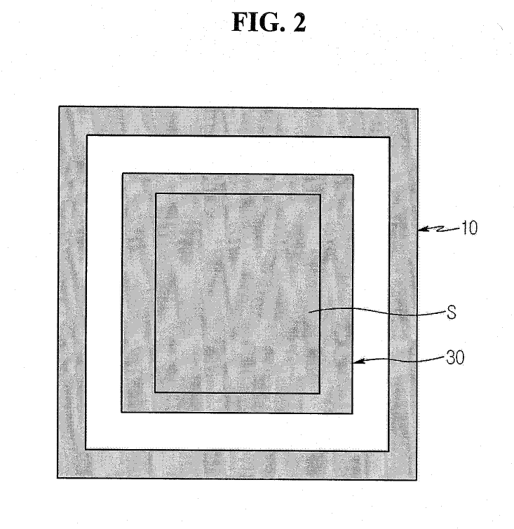

FIG. 1 shows the configuration of one type of process chamber and FIG. 2 shows another view of this chamber. As shown, the process chamber includes a chamber 10 for performing a substrate treatment process. This chamber includes a gate 11, an upper electrode 20, and a lower electrode 30. The gate is located on a side of the chamber for creating a vacuum state in the chamber. The upper electrode is located at an upper position in the chamber and the lower electrode is located under the upper electrode. A substrate (S) is placed on the lower electrode.

The upper electrode is formed from a shower head 22 which sprays process gas onto the substrate. The shower head includes a plurality of gas diffusing holes 24 each having a very small diameter. Process gas is uniformly supplied to a space between electrodes 20 and 30 through the holes in the shower head. The process gas is converted into plasma by applying high-frequency power to the electrode(s) and the surface of the substrate is treated using the plasma.

The lower electrode 30 includes a base plate 32, an insulating material 34 on the base plate, a cooling plate 36 on the insulating material, and a lower electrode material 38 on the cooling plate. An insulator 50 is provided around the lower electrode on which substrate S is supported for plasma treatment. The electrode material is made of aluminum, which is relatively cheap and widely used, and insulator 50 functions to prevent corrosion of the aluminum-containing electrode material from chemical reactions with the plasma formed by electric discharge of the gas flowing into the lower electrode when high voltage applied between the lower and upper electrodes.

That is, in order to protect the lower electrode from the plasma, the insulator includes insulating plates 52a and 52b located around an upper portion of the lower electrode, and ceramic plates 54a and 54b adhered around the insulating plates. During treatment, substrate S is placed only on the top surface of the lower electrode, which is not covered with ceramic plate 54b of the insulator. The lower electrode may be fabricated so that the size of the surface of the lower electrode corresponds to that of a substrate having a predetermined area.

Because the lower electrode assembly is fabricated to correspond to the size of the substrate to be processed, substrates of different sizes cannot be etched and ashed after the substrates are placed thereon. For example, a substrate having a 1200×1300 size cannot be placed on a lower electrode assembly fabricated to correspond to an 1100×1300 size. Such a substrate, therefore, cannot be etched or ashed using the apparatus of FIG. 1. A lower electrode assembly that corresponds to the 1100×1300 size must therefore be specially made to handle these types of substrates, resulting in increased costs.

Moreover, to accommodate different processing capabilities, a work place must include multiple processing apparatuses each having lower electrode assemblies that handle different size substrates. These processing apparatuses consume space and also increase costs.

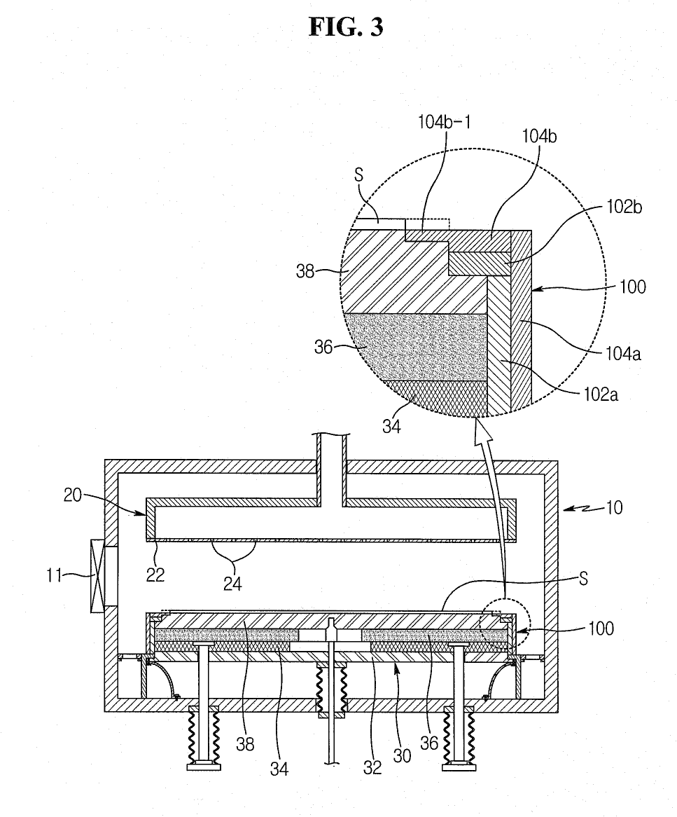

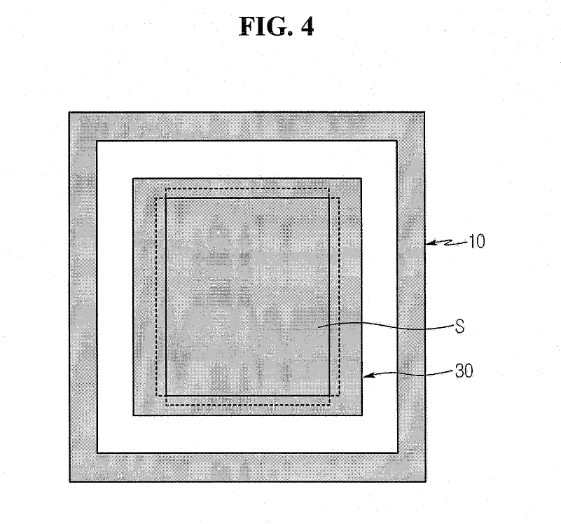

FIG. 3 shows one embodiment of another type of lower electrode assembly that may be used in a substrate processing apparatus, and FIG. 4 shows another view of this assembly. Where applicable, like reference numerals are used for like features relative to FIG. 1. The substrate processing apparatus may be included in a process chamber, and the lower electrode assembly may be used in the processing of substrates including semiconductor substrates to be used in flat panel displays as well as other electronic devices.

As shown in FIGS. 3 and 4, the process chamber includes a chamber 10 including a gate 11, an upper electrode 20, and a lower electrode 30. The gate is provided on one side of the chamber for creating a vacuum state in the chamber. The upper electrode is located at an upper position of the chamber, and the lower electrode is located under the upper electrode. A substrate (S) is supported by the lower electrode.

The upper electrode is provided with a shower head 22 for spraying process gas onto the substrate. The shower head 22 includes a plurality of gas diffusing holes 24, each having a very small diameter. Process gas is uniformly supplied to a space between the electrodes through the holes in the shower head, and the gas is converted into plasma, for example, by applying high-frequency power to the electrodes. The surface of the substrate is treated using the plasma. The substrate is placed on the lower electrode and treated. The lower electrode may be coupled to a radio frequency (RF) power source for generating the plasma.

The lower electrode 30 includes a base plate 32, an insulating material 34 placed on the base plate, a cooling plate 36 on the insulating material, and a lower electrode material 38 on the cooling plate. Because the substrate S is treated on lower electrode material 38, treatment of the substrate may be influenced by an increase in the temperature inside chamber 10. In order to prevent the temperature of the chamber or substrate from increasing to a predetermined temperature or higher, lower electrode 30 is provided with cooling plate 36.

The cooling plate includes a coolant passage for circulating coolant. When circulating in this passage, the cooling plate prevents the lower electrode from exceeding a predetermined temperature. The cooling plate, therefore, maintains the temperature of substrate S at a constant level or to within a predetermined range of temperatures.

An insulator 100 is provided around lower electrode material 38 of the lower electrode in order to prevent the corrosion of the lower electrode material due to plasma treatment. The insulator includes insulating plate 102a that covers a side or peripheral portion of a lower portion of lower electrode material 38, a side or peripheral portion of cooling plate 36, a side or peripheral portion of insulating material 34, and a side or peripheral portion of base plate 32. The insulator also includes a ceramic plate 104a that covers an outer surface of insulating plate 102a.

In accordance with one embodiment, insulating plate 102a is provided vertically around a side or peripheral portion of the lower portion of lower electrode material 38, cooling plate 36, insulating material 34 and base plate 32. When provided in this manner, insulating plate 102a comes into contact with the side or peripheral portions and the aforementioned features. The ceramic plate 104a may also be provided vertically on and in contact with the outer side of insulating plate 102a.

The insulator 100 further includes an insulating plate 102b and a ceramic plate 104b which are horizontally provided around an upper portion of the lower electrode material 38 that, for example, extends beyond substrate S. The plates of the insulator, therefore, cover surfaces of lower electrode material 38, cooling plate 36, insulating material 34 and base plate 32 that, for example, are not located directly under substrate S and therefore which may be susceptible to corrosion or other adverse effects from plasma generated in the chamber.

In accordance with one application, the upper portion of lower electrode material 38 may have a three-step structure that includes a first level surface on which substrate S is placed, a second level surface having a lower step height than the first level surface, and a third level surface having a lower step height than the second level surface. This structure is shown in the enlarged view of FIG. 3.

The third level surface corresponds to t he lower portion of the lower electrode material, and the height of the third level surface is lower than that of the first level surface. As further shown in FIG. 3, insulating plate 102a is vertically provided such that its height is the same as that of the third level surface (e.g., has an upper surface substantially in alignment with an upper surface of the third level surface) of lower electrode material 38. The ceramic plate 104a is vertically provided on the outer side of the insulating plate 102a, so that the height of plate 104a is the same as that of (e.g., has an upper surface substantially in alignment with) the first level surface of lower electrode material 38. Thus, insulating plate 102a and ceramic plate 104a are provided in a stepped arrangement.

Because substrate S is placed on the first level surface of lower electrode material 38, the first level surface of the lower electrode material is formed such that its width and length are identical to, or at least substantially the same as, those of substrate S That is, when the width and length of the substrate are X and Y respectively, the first level surface of the lower electrode material are also X and Y respectively.

The second level surface of the lower electrode material is formed to have a width which is a predetermined increment (+α) plus the predetermined width X of the first level surface and a length which is another increment (+β) plus the predetermined length Y of the first level surface. Here, α and β may be the same or different. According to one exemplary application, the difference in height between the first and second level surfaces is about 2˜10 mm.

Arranged in this manner, an insulating plate 102b may be horizontally provided on the third level surface of lower electrode material 38 and the top surface of insulating plate 102a. Ceramic plate 104b is horizontally provided on the insulating plate 102b and the second level surface.

Ceramic plate 104b, which is layered on insulating plate 102b and the second level surface of the lower electrode material, includes extension portion 104b-1 layered on the second level surface of the lower electrode material and a portion layered on insulating plate 102b, and may therefore be formed to have an inverted “L” shape. The reason for this is that extension portion 104b-1 may be formed, for example, to have a thickness of 2˜10 mm, which corresponds to the difference in height between the first level surface and the second level surface of the lower electrode material.

For this reason, in the region of the width or length of the second level surface of α or β, the difference in the height between the first level surface and the second level surface of the lower electrode material 38 is not large and thus the top surface of ceramic plate 104b on the second level surface, that is, the top surface of the extension portion 104b-1, can easily electrically communicate with lower electrode material 38.

Hence, as shown in FIGS. 3 and 4, a substrate having the same width and length of X and Y as the first level surface can be placed, etched and ashed on lower electrode material 38. Additionally, a substrate having a width which is an increment (+α) plus the predetermined width X of the first level surface and a length which is another increment (+β) plus the predetermined length Y of the first level surface can also be placed, etched and ashed on the lower electrode material.

In the foregoing example, the reason why the height difference between the first and second level surfaces of lower electrode material 38 may be set to 2˜10 mm is that, when the height difference is above 10 mm the peripheral portion of substrate S, which is placed on extension portion 104b-1 of the ceramic plate placed on the second level surface of the lower electrode material, is not properly treated. When the height difference is below 2 mm, it is difficult to fabricate a lower electrode assembly due to working problems.

Thus, one or more embodiments disclosed herein provide a lower electrode assembly for manufacturing substrates to be included, for example, in a flat panel display. This assembly is able to accommodate substrates of different sizes for etching, ashing, or other forms of processing, thereby decreasing business expenses. These embodiments may also reduce the area of a work space required to process substrates of different sizes, thereby further decreasing costs.

In accordance with one embodiment, a lower electrode assembly comprises a lower electrode material, which is disposed at an upper portion of the lower electrode assembly and on which a substrate is placed, wherein a circumference of the lower electrode material has a multiple-step structure comprising: a first level surface on which a substrate having a predetermined width and a predetermined length is placed; a second level surface having a width which is an increment (+α) plus the predetermined width (X) and a length which is another increment (+α) plus the predetermined length (Y); and a third level surface having a lower height than the second level surface, wherein an insulator is horizontally provided on the second level surface and third level surface, respectively.

In this case, it is preferred that the circumference of the lower electrode assembly be vertically provided therearound with an insulator dually layered with an insulating plate and a ceramic plate, and that the second level surface and third level surface of the lower electrode material be horizontally provided thereon with an insulator dually layered with an insulating plate and a ceramic plate.

Further, it is preferred that an insulating plate be horizontally provided on the third level surface of the lower electrode material, and that a ceramic plate be horizontally provided on the insulating plate and the second level surface of the lower electrode material.

Here, it is more preferred that the top surface of the ceramic plate and the first level surface be in the same plane, and that the difference in height between the first level surface and second level surface of the lower electrode material be 2˜10 mm.

Any reference to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A lower electrode assembly, comprising
an insulator; and
a lower electrode material including a peripheral portion that includes:
a first level surface to support a substrate having a predetermined width and length,
a second level surface having a width corresponding to the predetermined width of the substrate plus a first increment and a length corresponding to the predetermined length of the substrate plus a second increment,
a third level surface having a lower height than the second level surface,
wherein the insulator is provided horizontally on the second level surface and third level surface.

2. The assembly of claim 1, wherein the insulator includes:
a first insulating plate provided vertically around the lower electrode material;
a first ceramic plate provided vertically and adjacent to the first insulating plate;
a second insulating plate provided horizontally over at least the third level surface; and
a second ceramic plate provided horizontally over the second insulating plate and the second level surface.

3. The assembly of claim 2, wherein a top surface of the second ceramic plate is substantially aligned with the first level surface.

4. The assembly of claim 3, wherein the second ceramic plate has:
a first lower surface over the second level surface of the lower electrode material, and
a second lower surface over the third level surface of the lower electrode material and a top surface of the first insulating plate.

5. The assembly of claim 2, wherein the first insulating plate is provided vertically around a lower peripheral portion of the lower electrode material without covering other peripheral portions of the lower electrode material.

6. The assembly of claim 5, wherein a top surface of the first insulating plate is substantially aligned with the second level surface.

7. The assembly of claim 2, wherein the first ceramic plate is in contact with the second ceramic plate, and wherein top surfaces of the first ceramic plate and second ceramic plate are in substantially alignment in a same plane with the first level surface of the lower electrode material.

8. The assembly of claim 2, wherein the first and second insulating plates and the first and second ceramic plates are made from one or more materials that prevent plasma from impinging on the lower electrode material underlying the insulator.

9. The assembly of claim 2, wherein the first insulating plate covers a peripheral portion of a lower portion of the lower electrode material, a peripheral portion of a cooling plate under the lower electrode material, and an insulating material under the cooling plate.

10. The assembly of claim 2, wherein a difference in height between the first level surface and second level surface of the lower electrode material lies in a range of between 2 and 10 mm.

11. The assembly of claim 2, wherein a difference in height between the first and second levels surfaces is smaller than a difference in height between the second and third level surfaces.

12. The assembly of claim 1, wherein the first increment and second increment are substantially the same.

13. The assembly of claim 1, wherein the first increment and second increment are different.

14. A method for controlling plasma exposure, comprising:
forming an insulator over a peripheral portion of an electrode assembly, the electrode assembly including an electrode material layer supporting a substrate to be processed, the electrode material layer including a first level surface, a second level surface, and a third level surface, said forming including:
forming a first insulating plate vertically around the electrode material;
forming a first ceramic plate vertically around and adjacent to the first insulating plate;
forming a second insulating plate horizontally over at least the third level surface of the electrode material layer; and
forming a second ceramic plate horizontally over the second insulating plate and the second level surface of the electrode material layer.

15. The method of claim 14, wherein the second ceramic plate has:
a first lower surface over the second level surface of the electrode material layer, and
a second lower surface over the third level surface of the electrode material layer and a top surface of the first insulating plate.

16. The method of claim 14, wherein the first insulating plate is provided vertically around a lower peripheral portion of the electrode material layer without covering other peripheral portions of the electrode material layer.

17. The method of claim 16, wherein a top surface of the first insulating plate is substantially aligned with the second level surface.

18. The method of claim 14, wherein the first ceramic plate is in contact with the second ceramic plate and wherein top surfaces of the first ceramic plate and second ceramic plate are in substantially alignment with the first level surface of the electrode material layer.

19. The method of claim 14, wherein the first and second insulating plates and the first and second ceramic plates are made from a material that blocks plasma, thereby preventing plasma from impinging on the electrode material layer.

20. The method of claim 14, wherein a difference in height between the first level surface and second level surface of the electrode material layer lies in a range of between 2 and 10 mm.
